(19) United States
(12) Patent Application Publication
(10) Pub. No.: US 2017/0157832 A1
(43) Pub. Date: Jun. 8, 2017

(54) SYSTEM FOR THE FURTHER TREATMENT OF PREFORMS PRODUCED BY MEANS OF INJECTION MOLDING

(71) Applicant: MHT MOLD & HOTRUNNER TECHNOLOGY AG, Hochheim (DE)

(72) Inventors: Christian Wagner, Mainz (DE); Helmut Thommes, Kastel-Staadt (DE); Rainer Petry, Klein-Winternheim (DE)

(21) Appl. No.: 15/325,075

(22) PCT Filed: Aug. 21, 2015
(86) PCT No.: PCT/EP2015/069250

§ 371 Date: Jan. 9, 2017

(30) Foreign Application Priority Data
Aug. 29, 2014 (DE) 10 2014 112 438.3

(51) Int. Cl. B29C 49/12; B29C 45/17; B29C 49/06; B29C 49/42; B29C 45/00

(52) U.S. Cl. CPC B29C 49/12; B29C 49/4205; B29C 49/4273; B29C 45/0055; B29C 49/421; B29C 49/06; B29C 45/17; B29C 2045/1707; B29B 11/06

(57) ABSTRACT

The present invention concerns a system for the further treatment of hollow body preforms produced by injection molding, comprising
i) a receiving plate having at least one receiving cavity for receiving a preform,
ii) a post-treatment system which has
a) a post-treatment plate,
b) at least one impression pin provided for changing the internal contour of the profile by either coming into contact with the inside of the preform during the post-treatment or closing the preform and acting on the inside space with a fluid under pressure, whereby the preform is inflated, and
c) at least one post-treatment element which is provided for passing into the interior of a preform received in the receiving cavity or coming into contact with the preform, and
iii) a movement device with which the receiving plate can be reciprocated relative to the post-treatment plate between a first position in which the impression pin is positioned within the receiving cavity, a second position in which the post-treatment element is positioned within the receiving cavity or comes into contact with a preform received therein, and a third position in which neither the impression pin nor the post-treatment element is positioned within the receiving cavity or comes into contact with a preform received therein.

The present invention concerns a system for the further treatment of preforms produced means of injection molding.

By way of example commercially usual PET bottles are generally produced by stretch blow molding of the hollow body preform. In that process the hollow body preform is produced in a first step by means of injection molding. The stretch blow molding shaping operation which follows the injection molding operation is generally effected at a later time. A high level of effort and expenditure is required in the production of the corresponding injection molding molds as the injection molding mold on the one hand must be designed for very high pressures and on the other hand must also have suitable heated and/or cooled passages.

Usually an injection molding tool for the production of PET preforms comprises a large number of, for example 192, cavities into which tool cores of a suitable configuration are introduced. When the tool is closed, that is to say when the core is fitted into the corresponding cavity, a space, the so-called molding cavity, is formed between the core on the one hand and the cavity on the other hand. The plasticized plastic, for example PET, is then injected into that space under high pressure. As soon as the PET preform has sufficiently cooled down the mold can be opened and the preform removed.

To reduce the cycle times, that is to say the time from an injection operation to the next injection operation, it is already usual for the preform to be removed from the mold at a very early moment in time at which the preform is already set at its outside surfaces but its inner region is still fluid. In that condition the preform is generally transferred into the receiving element which generally has a receiving cavity in which the preform can be accommodated. In general a so-called receiving plate is used, which generally comprises a group of receiving cavities, wherein each receiving cavity can receive a preform.

Thus for example in the case of the so-called vertical tools, that is to say those injection molding tools which open by a vertical movement of the one tool portion relative to the other, it is possible for the tool mold to be already opened after for example ten seconds, for a receiving plate with corresponding receiving cavities to be introduced into the mold, for the individual preforms to be allowed to drop into the receiving cavities under the force of gravity, for the receiving plate with the preforms to be moved out of the tool, for the mold to be closed again, and for the next injection molding operation to begin. During the next injection molding operation the previous preforms remain in the receiving cavity which is usually cooled.

The receiving plate therefore has at least one receiving cavity for receiving a preform and a device for moving the receiving plate between two tool halves of an opened injection molding mold into a first removal position and for moving the receiving plate out of the opened injection molding mold into a first post-treatment position.

With that structure the receiving plate is moved between the mold tool halves of the opened mold tool in order to transfer the preforms directly from the mold tool into the receiving cavities of the receiving plate. As an alternative thereto it is also possible to provide an additional removal device which receives the preforms from the mold tool and transfers them to the receiving plate.

As the preform has to stay in the receiving cavity for a comparatively long time for cooling thereof so that generally the next preform can already be removed from the injection molding tool before the preform has cooled down in the receiving cavity to such an extent that it can be removed without the risk of damage it is already usual to use receiving plates having a plurality of groups of receiving cavities, wherein each group has as many receiving cavities as the injection molding tool provides preforms for each injection cycle. The individual receiving cavity groups are then successively provided with preforms so that the individual preform can remain in the receiving cavity for longer than an injection molding cycle.

In order further to reduce the post-treatment time in the receiving plate it has already been proposed in EP 2 358 513 B1 for a post-treatment pin to be introduced into the preform, wherein cooling fluid is sucked out of the bottom region of the preform by way of the tip of the post-treatment pin. In that case cooling fluid is supplied by way of an annular gap formed between the cooling pin and the inside wall of the preform. Thus the preform is cooled not only from the outside but also from the inside.

The known methods however suffer from the disadvantage that they only allow the post-treatment of a preform, whose external contour is substantially predetermined by the internal contour of the cavity of the injection molding tool.

The contour of the preform however then also has to take account of fluidic particularities which are to be noted when filling the mold cavity with the plasticized molten material. In general the mold cavity is filled by way of the bottom of the preform with the injection molding mold closed. The consequence of this is that the effective cross-section must be selected to be relatively large in particular in the bottom region as the complete mold cavity has to be filled by way of the bottom region.

The consequence of this is that the bottom of the preform frequently contains more PET than necessary and in addition the curvature in the bottom region has to be matched to fluidic particularities.

DE 10 2012 004 613 A1 describes a method of producing an optimized bottom contour in which a pressure body mechanically shapes and stretches the dome of the preform.

WO 2010/149522 describes a method of producing preforms in which the preform is expanded within a cavity.

The object of the present invention therefore is to provide a post-treatment system for preforms, which allows the production of preforms with an external contour that differs from the internal contour of the tool cavity.

According to the invention this is achieved in that, besides the receiving plate already described above, the system also has a post-treatment plate which has at least one impression pin which is provided for changing the internal contour of the preform by either coming into contact with the inside of the preform during the post-treatment and/or closing the preform and acting on the inside space with a fluid under pressure whereby the preform is expanded, and has at least one further post-treatment element which is provided for passing into the interior of a preform received in the receiving cavity or coming into contact with the preform.

Therefore by means of the impression pin the preform is either shaped by direct contact and/or or expanded by the supply of fluid.

In addition according to the invention there is provided a movement device with which the receiving plate can be reciprocated relative to the post-treatment plate between a first position in which the impression pin is positioned within the receiving cavity, a second position in which the post-treatment element is positioned within the receiving cavity or comes into contact with a preform received therein, and a third position in which neither the impression pin nor the post-treatment element is positioned within the receiving cavity or comes into contact with a preform received therein.

According to the invention therefore an impression pin is used within a post-treatment system, the pin shaping at least the inside of the preform. That can be implemented on the one hand by the impression pin coming into contact with the inside of the preform so that during the post-treatment the preform is stretched by virtue of the force exerted on the preform by way of the impression pin. On the other hand this can be effected by the impression pin sealing off the hollow body preform and introducing a pressure fluid into the preform whereby a force is exerted on the inside surfaces of the preform and the preform is expanded. At least for the latter alternative—but preferably also in the first alternative—the receiving cavity is such that the internal contour thereof is at least portion-wise larger than the external contour of the preform to be post-treated. It will be appreciated however that the two alternatives can also be combined so that the impression pin both comes into shaping contact with the preform and also passes a fluid into the interior of the preform to expand the preform.

Desirably for that purpose the receiving element is so designed that its internal contour at least in the bottom region of the preform is markedly larger than the external contour of the preform removed from the injection molding mold so that the shape of the preform can be changed at least in the bottom region by means of the impression pin in such a way that after processing by means of the impression pin the external contour of the preform is the same as the internal contour of the receiving element.

As generally the fluid molten material is fed by way of the bottom region of the preform during the injection molding procedure the thickness of the preform in the bottom region is not only determined by the demands on the bottle to be produced, but also by the fluidic demands of the mold tool. In other words the wall thickness of the preform in the bottom region frequently has to be thicker than is necessary for the bottle to be produced as it is through that region during the injection molding operation that the molten material for the entire preform has to be passed. The wall thickness of the preform can be further reduced after the injection molding operation by the processing by means of the impression pin in accordance with the invention.

In a preferred embodiment the impression pin is moveable relative to the post-treatment plate. That can be implemented for example by the impression pin being biased in the direction of the receiving element by means of a spring. As an alternative thereto this can be effected for example by the impression pin having a piston which can be acted upon with a pressure fluid to move the impression pin in the direction of the receiving element.

The post-treatment element can be for example an ejection element having a holding device for selectively holding a preform. As an alternative thereto the post-treatment element can be a post-treatment pin having a fluid passage, through which fluid can be introduced into the interior of a preform received in the receiving cavity or sucked out of same. In this case the post-treatment pin is as far as possible of such a configuration that it does not come into contact with the received preform or at least not in the bottom region thereof.

In addition there can be provided a device for moving the receiving plate between two tool halves of an opened injection molding mold into a first removal position and for moving the receiving plate out of the opened injection molding mold into a first post-treatment position. As an alternative thereto it would be possible to provide a separate transfer device with which the preforms are transferred from the mold tool into the receiving cavities of the receiving plate.

In a preferred embodiment the receiving plate has at least two and preferably three groups of receiving cavities, wherein each group has a plurality of, for example 192, receiving elements, and the groups are arranged at a spacing a from each other, wherein the device for moving the receiving plate is so adapted that it can move the receiving plate into at least two different positions, the first removal position and a second removal position, between two opened tool halves, which are spaced from each other at the spacing a.

The provision of a plurality of groups of receiving elements means that a plurality of groups of preforms can be successively removed from the injection molding mold without the previous preform group having to leave the post-treatment tool.

The residence time of a preform in the post-treatment system is therefore longer than an injection molding cycle.

In a further embodiment the device for moving the receiving plate is so adapted that it can move the receiving plate into at least two different positions, the first removal position and a second removal position, between two opened tool halves, which are spaced from each other at the spacing a.

In a further preferred embodiment the device for moving the receiving plate is so adapted that it can move the receiving plate into at least two different positions, the first post-treatment position and the second post-treatment position, outside the tool halves, which are spaced at the spacing a from each other.

In a further particularly preferred embodiment it is provided that the post-treatment system has a group of impression pins and a group of post-treatment elements which are spaced from each at a spacing a, which are so adapted that in the first position the impression pins are positioned within the first group of receiving cavities and the post-treatment elements are positioned within the second group of receiving cavities or come into contact with preforms received therein, and in the second position the impression pins are positioned within the second group of receiving cavities and the post-treatment elements are positioned within the first group of receiving cavities or come into contact with preforms received therein.

In other words the post-treatment plate can either be moved into a first post-treatment position relative to the receiving plate, in which the impression pin comes into contact with the first group of receiving elements while for example the ejection elements come into contact with the second group of receiving elements, or moved into a second post-treatment position in which the group of impression pins is brought into contact with the second group of receiving elements while the group of ejection elements cooperates with the first group of receiving elements. In the first post-treatment position therefore the preforms which are in the first group of receiving elements are post-treated by means of the impression pins, that is to say in particular the bottom region thereof is stretched by virtue of the action of the impression pin within the post-treatment element. At the same time the ejection elements which for example can be in the form of sleeves engageable into the preforms engage into the second group of preforms which are within the second group of removal elements. The ejection elements can then be actuated, that is to say they can be connected for example to a vacuum source so that, when the receiving plate moves away from the post-treatment plate, the preforms which are connected to the ejection elements remain on the ejection elements while the preforms which have just been processed by the impression pins remain within the post-treatment elements. The receiving plate is then moved into the opened injection molding mold again to receive the next group of preforms. During the receiving process the preforms on the ejection elements are ejected by for example the sleeve being subjected to an increased pressure.

The receiving plate is then moved out of the tool again and this time moved into the other post-treatment position so that now those preforms which have been previously processed by means of the impression pin can be seized by the ejection elements while the preforms which have just been removed from the injection molding mold are now processed by means of the impression pins.

In a further preferred embodiment it is provided that the post-treatment system has a group of impression pins and a group of post-treatment elements which are spaced from each at a spacing a, which are so adapted that in the first position the impression pins are positioned within the first group of receiving cavities and the post-treatment elements are positioned within the second group of receiving cavities or come into contact with preforms received therein, and in the second position the impression pins are positioned within the second group of receiving cavities and the post-treatment elements are positioned within the first group of receiving cavities or come into contact with preforms received therein.

In another preferred embodiment the post-treatment system has at least one further group of post-treatment elements, wherein the one group of post-treatment elements is formed by ejection elements and the other group of post-treatment elements is formed by post-treatment pins with fluid passage.

In that case the receiving plate should have at least three groups of receiving elements.

That ensures that each preform group is processed firstly by means of the impression pins, then processed by means of the post-treatment pins with fluid passage and finally removed from the receiving plate by means of the ejection element. Either fluid can be blown into the preforms or can be sucked out of same, by means of the post-treatment pins. The aim in that respect is to produce a cooling fluid flow within the preform, which flows along the hollow-cylindrical passage formed between the post-treatment pins and the preform to achieve effective cooling of the inside of the preform.

In a preferred embodiment the post-treatment plate has an impression plate moveable relative to the post-treatment plate, wherein the impression pin or the group of impression pins is fixed to the impression plate and the impression pin or the group of impression pins extends through one or more openings in the post-treatment plate, wherein preferably the post-treatment plate and the impression plate are connected together by way of a column guide means. Alternatively the impression plate can naturally also have openings through which the further post-treatment elements extend.

It has been found that a movement of the impression pins relative to the preforms, which is independent of the movement of the post-treatment pins relative to the preforms, is advantageous. Thus for example it may be useful if the impression pin moves slowly axially during a complete injection molding cycle in order to stretch the bottom of the preform. At the same time however a movement of the post-treatment pin and/or the ejection element which is also fixed to the post-treatment plate is not wanted.

In addition this configuration allows the post-treatment plate to be connected to the moveable half of the injection molding tool. More specifically the consequence of this is that, whenever the injection molding tool is closed, the post-treatment plate moves in the direction of the appropriately positioned receiving plate. Then, if desired, when the injection molding tool is closed the impression pin can be moved separately.

Basically there are three preferred options with which the impression pins exert force on the inside of the preform and shape it:

1) Provision of impression pins immobile with respect to the post-treatment plate and movement of the post-treatment plate into the first or second position,

2) Provision of impression pins mobile with respect to the post-treatment plate with individual drive like for example a pneumatic drive and individual movement of the impression pins relative to the post-treatment plate in the first or second position of the removal plate, or

3) Provision of impression pins mobile with respect to the post-treatment plate with a common drive, for example by mounting the impression pins on a common moveable plate.

In particular in cases 2) and 3), after termination of the processing operation using the impression pins, the drive can be used to retract the impression pins relative to the preforms again.

In particular in case 2) a sensor device which monitors the correct processing position of the individual impression pins can be of advantage.

In a further preferred embodiment the impression pin or the group of impression pins has one or more openings through which fluid can be fed into the interior of the preform. In that case the impression pin is provided with a sealing element so that, when the impression pin is arranged within the preform, the preform is sealed off so that an increased pressure can be produced in the interior of the preform by the feed of fluid. The increased pressure causes blow shaping of the preform. In principle therefore it would be possible for the receiving elements to be provided with cavities whose internal contour corresponds to the external contour of the PET bottles to be produced. With such a device therefore the separate stretch blow molding operation which generally follows production of the preforms could be integrated at the same time in the post-treatment system. However such an arrangement would be practicable generally only when the outside diameter of the PET bottle to be produced is not markedly larger than the outside diameter of the preforms as otherwise the spacing of the cores and the cavities of the injection molding tool would have to be selected to be larger than necessary in order to leave space for the receiving elements disposed between two adjacent cores.

In addition it may be advantageous if the receiving cavity has a receiving opening by way of which a preform can be introduced into the receiving cavity and a fluid passage which is so arranged that with the receiving opening closed a fluid can be introduced into the receiving cavity by way of the fluid passage or removed from the receiving cavity, wherein the receiving cavity extends along a longitudinal axis and the fluid passage has a passage opening which is arranged on or in the proximity of the longitudinal axis and is arranged opposite the receiving opening, wherein disposed in the fluid passage in the region of the passage opening is a support element having a support surface which is intended to come into contact with the preform when the preform is fitted into the receiving cavity.

For example the post-treatment plate can be connected to the moveable tool half of the injection molding tool so that upon opening of the injection molding mold the post-treatment plate is moved relative to the removal plate. In general that tool half which has the mold cores is moveable as the plasticized PET molten material is fed by way of the mold cavities and therefore the effort and expenditure involved in the movement of the cavity side of the tool is greater.

Particularly when the post-treatment plate is connected only at one side to the moveable tool half, a preferred embodiment provides a locking device which in an activated condition provides a positively locking connection between the receiving plate and the post-treatment plate in the first and second positions, which has to be deactivated if the receiving plate is to be moved relative to the post-treatment plate into the third position. That movement prevents a deflection movement of the post-treatment plate relative to the removal plate by virtue of the force applied to the removal plate by the impression pins.

As an alternative thereto there could also be provided a support element or an abutment which supports the post-treatment plate at the side remote from the fixing to the tool half.

The described locking device can also be used according to the invention in a system for the further treatment of hollow body preforms produced by means of injection molding, comprising

i) a receiving plate having at least one receiving cavity for receiving a preform,

ii) a post-treatment system having at least one impression pin which is provided for changing the internal contour of the preform by either coming into contact with the inside of the preform during the post-treatment or closing the preform, and acting on the inside space with a fluid under pressure, whereby the preform is expanded,

iii) a movement device with which the receiving plate can be reciprocated relative to the post-treatment plate between a contact position in which the impression pin is positioned within the receiving cavity and a readiness position in which the impression pin is positioned outside the receiving cavity, and

iv) a locking device which in an activated condition provides a positively locking connection between the receiving plate and the post-treatment plate in the contact position, which must be deactivated if the receiving plate is to be moved relative to the post-treatment plate into the readiness position.

That system differs from that first described above only in that the post-treatment plate does not have an additional post-treatment element. All other features mentioned in connection with the first-described embodiment can self-evidently also be implemented with the embodiment without the additional post-treatment element. In this case the impression pin could also be in the form of the ejection element.

In rare cases it can happen that preforms do not remain in the cavity of the removal plate after processing by the impression pin, but remain clinging to the impression pin. The consequence of this is that the preform clinging to the impression pin is pressed into the next following preform, which results in both preforms being ruined.

To prevent this a preferred embodiment has a sensor device which monitors the impression pin, whereby it is possible to establish whether a preform has remained on the impression pin. The sensor device can for example have a light barrier arrangement, the light beam of which is interrupted if there is a preform on the impression pin.

Alternatively or in combination therewith the post-treatment plate can have a stripper device, which, when the receiving plate is moved out of the first or the second position into the third position, contacts the preform and removes it from the impression pin. The stripper device can comprise for example a resilient ring which is pressed on to the preform opening by means of a spring. When the post-treatment plate moves away from the receiving plate the resiliently prestressed ring will then push the preform from the impression pin.

Further advantages, features and possible uses of the present invention will be apparent from the description hereinafter of a preferred embodiment. In the drawing:

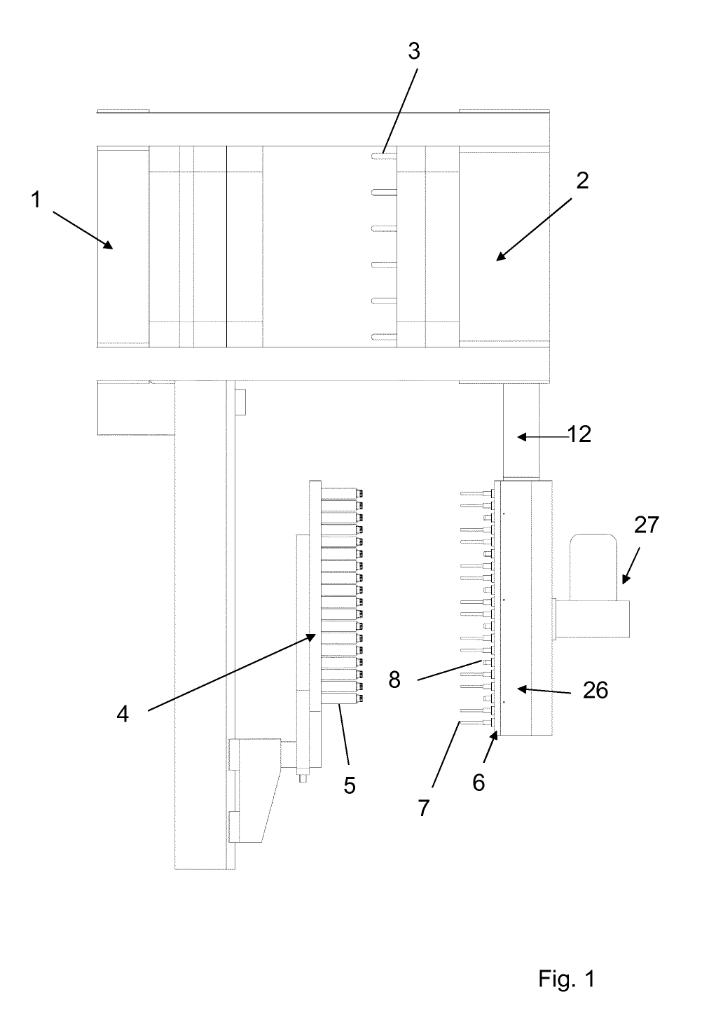

FIG. 1 shows a diagrammatic view of a PET injection molding system with post-treatment unit, and

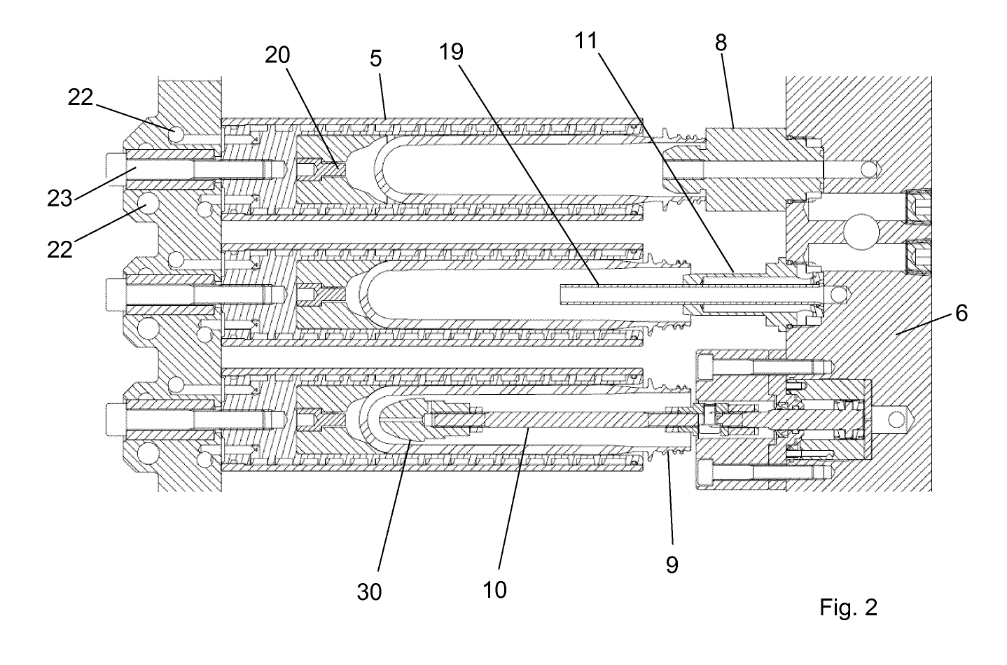

FIG. 2 shows a sectional view of a first embodiment according to the invention.

FIG. 1 shows a diagrammatic view of a PET injection molding system with post-treatment unit. The injection molding mold comprises two plates 1, 2 which are moveable relative to each other, wherein one plate 1 is stationary and one plate 2 is moveable in the illustrated embodiment.

The one plate has cores 3 while the other plate has corresponding cavities (not shown). The two plates can be moved relative to each other from an open position shown in FIG. 1 into a closed position in which the cores 3 of the moveable plate 2 are arranged in the corresponding cavities of the stationary plate 1. Between the cavities of the stationary plate 1 and the cores 3 of the moveable plate 2 the so-called mold cavity is then formed, being filled with plasticized PET, to constitute a preform.

As soon as the outer surfaces of the preform are cooled, that is to say have set, the mold is opened and a removal element 4 in the form of a plate is moved between the opened plates 1, 2. The preforms sitting on the cores 3 of the moving plate are then transferred into corresponding receiving elements which are also in the form of cavities.

In the illustrated example the injection molding tool has six cores, that is to say six preforms are produced in the injection molding cycle. The corresponding removal element 4 however has 18 (3×6) receiving elements 5 which can each receive a respective preform. The removal element 4 thus has three groups of receiving cavities which are successively fitted with corresponding preforms. As soon as the preforms have been transferred from the cores 3 on to the receiving elements 5 of the removal element 4 the removal element 4 is moved into the position shown in FIG. 1 again and the injection molding mold consisting of the two plates 1, 2 can be closed again. As in the illustrated embodiment the removal element is connected to the stationary plate 1 the post-treatment element 6 connected to the moving plate 2 moves towards the removal element 4. The post-treatment element 6 has a row of post-treatment pins 7 which, while the mold is closed, engage into the preforms held in the removal element 4.

The individual post-treatment pins are mounted on a pin plate. In addition transfer elements 8 or ejection elements are fixed to the pin plate, which serve for the transfer of the post-treated preforms from the receiving plate 4 on to the transfer elements 8 or the post-treatment element 6 respectively. Fixed to the post-treatment element 6 is a blower 27 which can produce increased pressure or reduced pressure in a pressure chamber 26. The entire post-treatment plate 6 is designed to be rotatable about the shaft 12 so that the post-treatment element can be rotated through 90° so that the preforms seated on the transfer element 8 can be ejected by the force of gravity.

It will be seen that the post-treatment element 6 has more pins than the receiving plate 4 has receiving cavities. The receiving plate can therefore be positioned in a plurality of different positions (in the illustrated example three) relative to the post-treatment element 6. The corresponding positions are adopted in succession, after a new respective group of preforms has been removed from the injection molding mold, so that the preform group held longest in the receiving plate 4 is respectively positioned with respect to the transfer elements 8 and can therefore be removed.

FIG. 2 shows a sectional view of an embodiment of the invention. Here, a transfer or ejection element 8 as well as a post-treatment element 7 is also shown at the pin plate 6. In addition the pin plate 6 here has an impression pin 10. FIG. 2 also shows the receiving element 5 which is cooled by way of the cooling passages 22, involving spiral passages. Compressed air or vacuum can be selectively supplied at the bottom of the receiving element 5 by way of the feed conduit 23 in order to either hold the preform 9 within the receiving cavity 5 or to eject it therefrom. The post-treatment pin 7 is concentrically surrounded by a sleeve 11, by way of which cooling air is passed into the interior of the preform, being discharged inter alia by way of the tip 19 of the post-treatment pin. There are also cooling passages 22, by means of which the post-treatment plate can be cooled, preferably being water-cooled.

In addition the receiving cavities 5 of the post-treatment plate in the illustrated embodiment, opposite the receiving opening by way of which a preform is inserted, have a fluid passage arranged on the central axis of the receiving cavity 5. Positioned in the fluid passage is a support element 20 with a support surface which, in the condition of being inserted into the receiving cavity, comes into contact therewith at least after processing with the impression pin.

During the post-treatment operation therefore the impression pin 10, the post-treatment pin 7 and the transfer element 8 are successively introduced into each preform. In that case the impression pin 10 serves to stretch at least the bottom region of the preform, that is to say to put it into a shape defined by the bottom of the receiving cavity and the external contour of the contact element 30 which is fixed to the impression pin 10.

### LIST OF REFERENCES

1, 2 plate

3 cores

4 removal element

5 receiving element

6 post-treatment element

7 post-treatment pin

8 transfer element

9 preform

10 impression pin

11 sleeve

12 shaft

19 tip

20 support element

22 cooling passages

23 feed means

30 contact element

1. A system for the further treatment of hollow body preforms produced by injection molding, comprising
i) a receiving plate having at least one receiving cavity for receiving a preform,
ii) a post-treatment system which has
a) a post-treatment plate,
b) at least one impression pin provided for changing the internal contour of the profile by either coming into contact with the inside of the preform during the post-treatment or closing the preform and acting on the inside space with a fluid under pressure, whereby the preform is inflated, and
c) at least one post-treatment element which is provided for passing into the interior of a preform received in the receiving cavity or coming into contact with the preform, and
iii) a movement device with which the receiving plate can be reciprocated relative to the post-treatment plate between a first position in which the impression pin is positioned within the receiving cavity, a second position in which the post-treatment element is positioned within the receiving cavity or comes into contact with a preform received therein, and a third position in which neither the impression pin nor the post-treatment element is positioned within the receiving cavity or comes into contact with a preform received therein.

2. A system as set forth in claim 1 characterised in that the posttreatment element is an ejection element having a holding device for selectively holding a preform.

3. A system as set forth in claim 1 characterised in that the posttreatment element is a post-treatment pin having a fluid passage through which fluid can be introduced into or sucked out of the interior of a preform received in the receiving cavity.

4. A system as set forth in claim 1 characterised in that the impression pin has a sealing element which can come into contact with the opening of the hollow body preform and seal same off and a fluid feed for introducing a fluid under pressure into the hollow body preform.

5. A system as set forth in claim 1 characterised in that the impression pin is moveable relative to the post-treatment plate.

6. A system as set forth in claim 1 characterised in that the receiving plate has at least two groups of receiving cavities, wherein each group has a plurality of receiving elements, and the groups are arranged at a spacing a from each other.

7. A system as set forth in claim 6 characterised in that the device for moving the receiving plate is so adapted that it can move the receiving plate into at least two different positions, the first removal position and a second removal position, between two opened tool halves, which are spaced from each other at the spacing a.

8. A system as set forth in claim 6 characterised in that the device for moving the receiving plate is so adapted that it can move the receiving plate into at least two different positions, the first post-treatment position and the second post-treatment position, outside the tool halves, which are spaced at the spacing a from each other.

9. A system as set forth in claim 6 characterised in that the post-treatment system has a group of impression pins and a group of post-treatment elements which are spaced from each at a spacing a, which are so adapted that in the first position the impression pins are positioned within the first group of receiving cavities and the posttreatment elements are positioned within the second group of receiving cavities or come into contact with preforms received therein, and in the second position the impression pins are positioned within the second group of receiving cavities and the post-treatment elements are positioned within the first group of receiving cavities or come into contact with preforms received therein.

10. A system as set forth in claim 9 characterised in that the posttreatment system has at least one further group of post-treatment elements, wherein the one group of post-treatment elements is formed by ejection elements and the other group of post-treatment elements is formed by post-treatment pins with fluid passage.

11. A system as set forth in claim 1 characterised in that the post-treatment plate has an impression plate moveable relative to the post-treatment plate, wherein the impression pin or the group of impression pins is fixed to the impression plate.

12. A system as set forth in claim 1 characterised in that the impression pin or the group of impression pins has one or more openings for the feed of fluid into the interior of the preform, wherein the 25 impression pin has a sealing element which is so adapted that when the impression pin is arranged within the preform it can seal off the preform so that an increased pressure can be produced in the interior of the preform by the feed of fluid.

13. A system as set forth in claim 1 characterised in that there is provided a locking device which in an activated condition provides a positively locking connection between the receiving plate and the post-treatment plate in the first and second positions, which has to be deactivated if the receiving plate is to be moved relative to the posttreatment plate into the third position.

14. A system for the further treatment of hollow body preforms produced by means of injection molding, comprising
i) a receiving plate having at least one receiving cavity for receiving a preform,
ii) a post-treatment system having at least one impression pin which is provided for changing the internal contour of the preform by either coming into contact with the inside of the preform during the posttreatment or closing the preform, and acting on the inside space with a fluid under pressure, whereby the preform is expanded,
iii) a movement device with which the receiving plate can be reciprocated relative to the post-treatment plate between a contact position in which the impression pin is positioned within the receiving cavity and a readiness position in which the impression pin is positioned outside the receiving cavity, and
iv) a locking device which in an activated condition provides a positively locking connection between the receiving plate and the posttreatment plate in the contact position, which must be deactivated if the receiving plate is to be moved relative to the post-treatment plate into the readiness position.

15. An injection molding system having a mold tool comprising two tool halves, wherein the one tool half has a multiplicity of cavities and the other tool half has a multiplicity of cores, and a further treatment system as set forth in claim 1.

16. An injection molding system as set forth in claim 1 characterised in that the receiving cavities are larger at least in the bottom region than the cavities of the mold tool.

17. An injection molding system as set forth in claim 15 characterised in that the post-treatment plate is connected to a tool half, wherein the post-treatment plate is preferably connected to the tool half which has the multiplicity of cores.

18. A system as set forth in claim 11 wherein the post-treatment plate and the impression plate are connected together by way of a column guide means.

19. A system as set forth in claim 18 wherein the impression pin or the group of impression pins extends through one or more openings in the post-treatment plate.

20. An injection molding system having a mold tool comprising two tool halves, wherein the one tool half has a multiplicity of cavities and the other tool half has a multiplicity of cores, and a further treatment system as set forth in claim 14.
